(19) United States
(12) Patent Application Publication
(10) Pub. No.: US 2011/0271572 A1
(43) Pub. Date: Nov. 10, 2011

(54) HOLLOW SELF-STICK ADVERTISEMENT DEVICE

(76) Inventor: Hsin-hsin LO, Taichung City (TW)

(21) Appl. No.: 12/817,467

(22) Filed: Jun. 17, 2010

(30) Foreign Application Priority Data
May 5, 2010 (TW) 099208316

(51) Int. Cl. G09F 3/10

(52) U.S. Cl. 40/638

(57) ABSTRACT

A hollow self-stick advertisement device includes a body, which has at least one attaching back surface to be attached to a commercial product with an adhesive substance, such as adhesives or an adhesive tape. The advertisement body forms at least one open area serving as a hollow viewing window that is set to correspond to indication and brand name formed on the commercial product so as not to affect the identification of the product but highlighting the identification. The body includes an additional area surrounding the viewing window to receive printings for advertisement other than the commercial product to be made thereon. The hollow self-stick advertisement device is easy to manufacture with low costs, provides a unique design for highlighting the advertisement, and is diversified in forms and can be made three-dimensional to provide enhanced effect of advertisement.

### BACKGROUND OF THE INVENTION

1. Field of the Invention

The present invention relates to the field of advertising, and in particular to a hollow self-stick advertisement device that can be adhesively attached to a commercial product or a shopping bag but not affecting the viewing of brand name or product indications formed on the product or the shopping bag and also provides an expanded area for making advertisement.

2. The Related Arts

It is often that a product cannot be prevailing if it is not known to the public or if it lacks of publicity or public reputation. Advertisement is one of the necessary ways to improve the publicity of a product or to get the product publicly known. For example, printings made on a packaging container of the product or a ticket or slip or small daily articles, such as tissue packs or stationeries that are arbitrarily distributed in street corners are examples of advertisement. Other examples include a banner attached to a vehicle, such as a truck or a bus, and printings made on the body of a vehicle, whereby mobile advertising can be made to display advertisement to passing pedestrians and motorists. However, these known ways of advertisement are of a single form for each advertisement and are in general not “three-dimensional”, so that it is generally not possible to provide diversified forms of advertisement or make an advertisement prominent.

In view of the problems discussed above, it is a challenge of the workers of the related fields, and also an expectation of the general consumers, to provide a practical device for enhanced effect of advertisement.

Thus, the present invention aims to provide a hollow self-stick advertisement device that overcomes the above discussed problems.

### SUMMARY OF THE INVENTION

The problem to be addressed by the present invention is that the known ways of advertisement are generally printings made on a packaging container of a product or a ticket or slip or small daily articles, such as tissue packs or stationeries that are arbitrarily distributed in street corners, or a banner attached to a vehicle, such as a truck or a bus and printings made on the body of a vehicle to provide mobile advertising that displays advertisement to passing pedestrians and motorists, but these known ways of advertisement are generally of a single form for each advertisement and are in general not “three-dimensional”, making it generally not possible to provide diversified forms of advertisement or making an advertisement prominent.

To solve such problems and drawbacks, the present invention provides a hollow self-stick advertisement device, comprising a body, which has at least one attaching back surface, which is adapted to attach to a commercial product with an adhesive substance, such as adhesives or an adhesive tape. The advertisement body forms at least one open area serving as a hollow viewing window that is set to correspond to indication and brand name formed on the commercial product so as not to affect the identification of the product but highlighting the identification. The body comprises an additional area surrounding the viewing window to receive printings for advertisement other than the commercial product to be made thereon. The hollow self-stick advertisement device is easy to manufacture with low costs, provides a unique design for highlighting the advertisement, and is diversified in forms and can be made three-dimensional to provide enhanced effect of advertisement. The hollow self-stick advertisements device can made of any desired size, showing excellent flexibility and convenience of use. An advertisement that is not associated with the commercial product to which the advertisement body of the present invention is attached is provided next to the product indication and brand name of the commercial product, whereby when a consumer purchases the commercial product, the consumer will be additionally attracted by the unique advertisement realized by the advertisement device of the present invention. Apparently, the advertisement device of the present invention provides the most effective way of advertisement.

As compared to the known ways of advertisement, the hollow self-stick advertisement device offers the advantages of being easy to manufacture with low costs, showing a unique design, making advertisement prominent, providing diversified and three-dimensional forms of advertisement, and providing excellent effect of advertisement.

The hollow self-stick advertisement device is simple and can be easily made popular to benefit the advertisement designs, the advertiser, the sale shop, and the manufacturers and can be arranged in the form that carrying “product points” to be collected by a consumer or in the form of coupon for benefiting the consumers.

There are a huge number of commercial products that are available in the market and each product is sold with a great number. This provides an unlimited prosperity to the future of the present invention. And, the present invention can be arranged in the form that carrying “product points” to be collected by a consumer or in the form of coupon for benefiting the consumers.

The present invention provides a simple model of advertisement and product promotion, which can be easily accepted by the general consumers. Due to the hollow viewing window, the original indication of a product to which the present invention is attached can be identified so that the sale of the product will not be affected by the advertisement device of the present invention attached to the product. Further, the advertisement device of the present invention offers an advantage of highlighting the identification of the original product.

When the advertisement device of the present invention is applied to a small article or product, excessive portions of the advertisement body can be bent and folded over sides of the product in a manner not affecting viewing of indication of product composition and barcode as well as other product information.

The present invention provides an advertisement device that forms an advertisement bridge that links the present invention to a commercial product so as to form various models of advertisement, and thus the present invention is applicable to all types of commercial products all over the world, including newspapers, magazines, journals, books, beverage cans, food stuff packages, drug packages, packages of household articles, wine bottles, cigarette boxes, beverage cups, soda cups, chewing gums, shopping bags, and the likes.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a first embodiment of the present invention;

FIG. 2 is a perspective view showing a second embodiment of the present invention;

FIG. 3 is a perspective view showing a third embodiment of the present invention;

FIG. 4 is a perspective view showing a fourth embodiment of the present invention;

FIG. 5 is a perspective view showing a fifth embodiment of the present invention;

FIG. 6 is a perspective view showing a sixth embodiment of the present invention;

FIG. 7 is a perspective view showing a seventh embodiment of the present invention;

FIG. 8 is a perspective view showing an eighth embodiment of the present invention;

FIG. 9A is a top-side perspective view showing an advertisement body of a hollow self-stick advertisement device in accordance with the present invention; and

FIG. 9B is a bottom-side perspective view showing an advertisement body of a hollow self-stick advertisement device in accordance with the present invention.

### DETAILED DESCRIPTION OF THE PREFERRED EMBODIMENT

The present invention provides a hollow self-stick advertisement device of which embodiments and examples will be described in details with reference to the attached drawings.

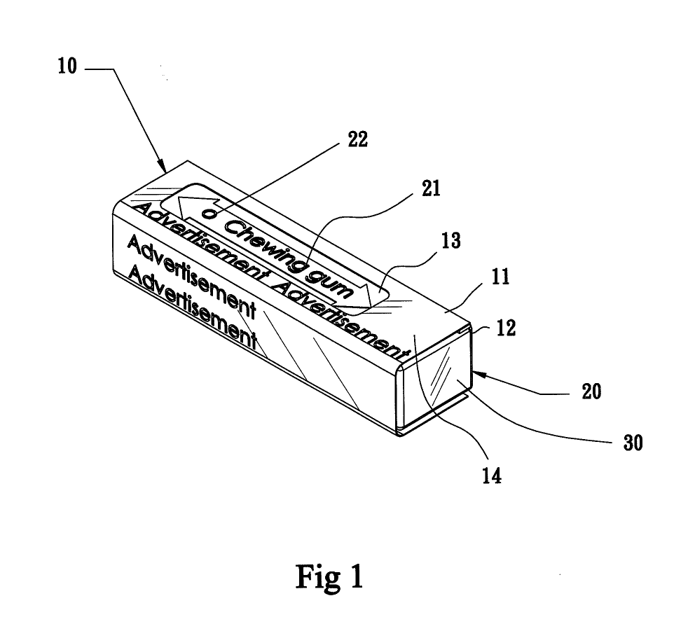

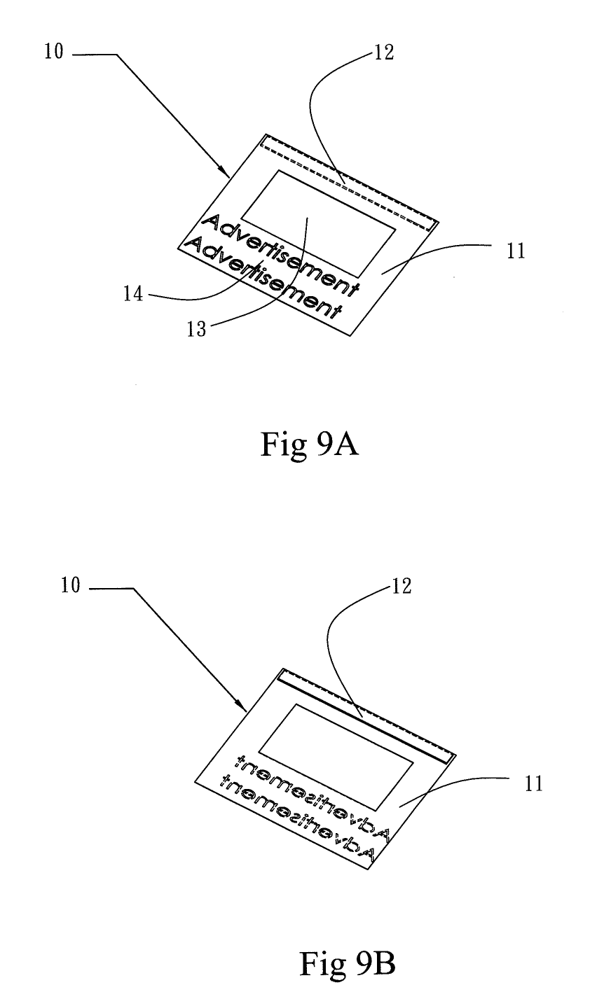

Reference is first made to FIGS. 1, 9A, and 9B, which are a perspective view showing a hollow self-stick advertisement according to a first embodiment of the present invention attached to a commercial product, and a top-side perspective view and a bottom-side perspective view of the hollow self-stick advertisement device of the first embodiment.

The hollow self-stick advertisement device according to the present invention comprises a body 10, which has an attaching back surface 11. The attaching back surface 11 can be attached to a commercial product 20 with an adhesive substance, such as adhesives or an adhesive tape 12. The advertisement body 10 forms at least one hole or open area serving as a hollow viewing window 13 that is sized according to the specification and size of the commercial product 20. The hollow viewing window 13 is set exactly corresponding, in position, to an indication or sign 21 and brand name or trademark 22 of the commercial product 20, so that the identification of the product 20 will not be negatively affected. The advertisement body 10 comprises additional area 14 surrounding the viewing window 13 and printings can be made on the surrounding area 14 for advertisement other than the product.

In the embodiment illustrated in FIG. 1, the commercial product 20 comprises a pack 30 of chewing gum, which has a surface to which an advertisement body 10 is adhesively attached. As shown in the drawing, through the viewing window 13 of the advertisement body 10, the indication or sign 21 and brand name 22 of the chewing gum pack 30 are still viewable and readable, making it not affecting the identification of the chewing gum pack 30, and also the indication 21 and the brand name 22 are even more prominent to a viewer. Except the viewing window 13, the advertisement body 10 comprises the additional area 14 surrounding the viewing window 13 to allow printings of texts or patterns made on the area to display advertisement other than the product itself, making the advertisement more eye attracting.

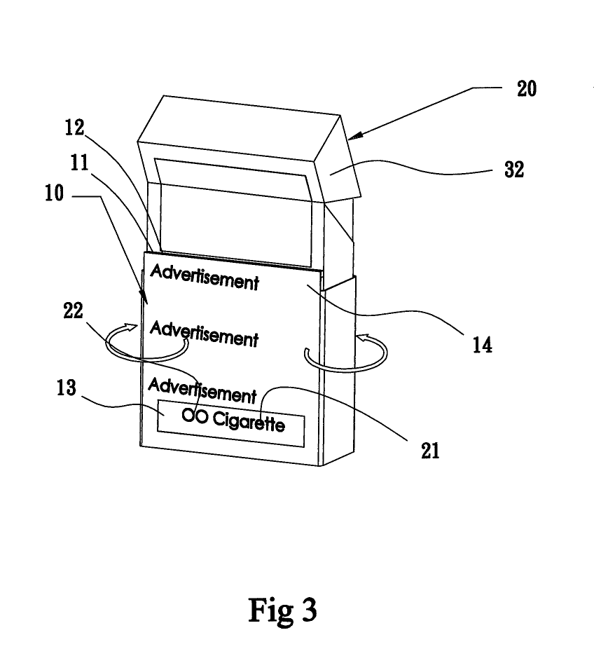

The advertisement body 10 is preferably made flexible, so that when the advertisement body 10 is applied to a small article or product 20, such as the chewing gum pack 30 (FIG. 1) or a cigarette box 32 (FIG. 3), excessive portions of the advertisement body 10 can be bent and folded over sides of the product 20 in a manner not affecting viewing of indication of product composition and barcode as well as other product information.

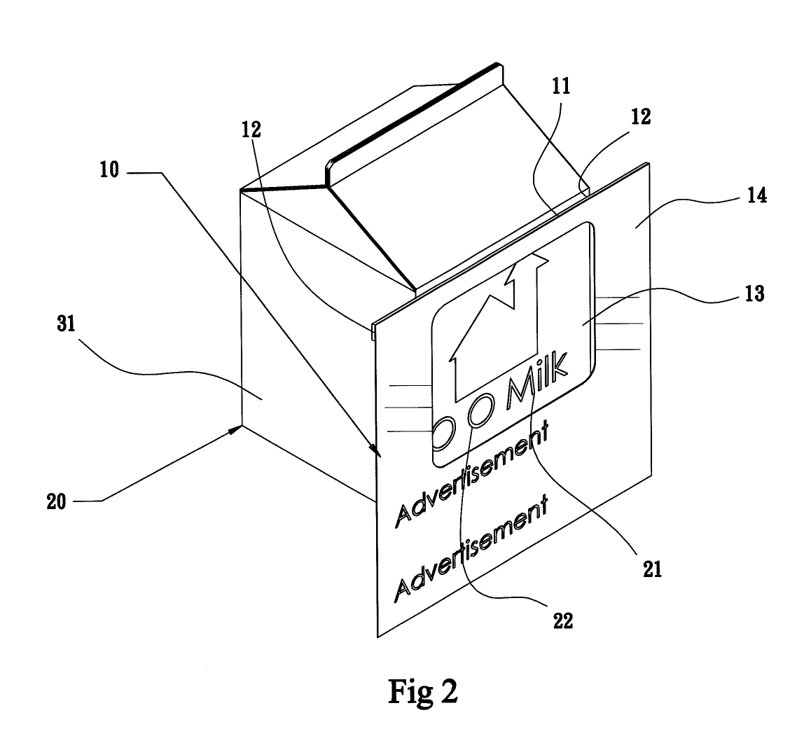

Referring to FIG. 2, an embodiment of the advertisement device according to the present invention applied to a commercial product 20 comprising a milk cartoon 31 is illustrated. In the illustrated embodiment, an advertisement body 10 is adhesively attached to the milk carton 31. The advertisement body 10 comprises a hollow viewing window 13 through which indication 21 and brand name 22 are visible and a surrounding area 14 displaying other advertisements.

Referring to FIG. 3, an embodiment of the advertisement device according to the present invention applied to a commercial product 20 comprising a cigarette box 32 is illustrated. In the illustrated embodiment, an advertisement body 10 is adhesively attached to the cigarette box 32. The advertisement body 10 comprises a hollow viewing window 13 through which indication 21 and brand name 22 are visible and a surrounding area 14 displaying other advertisements.

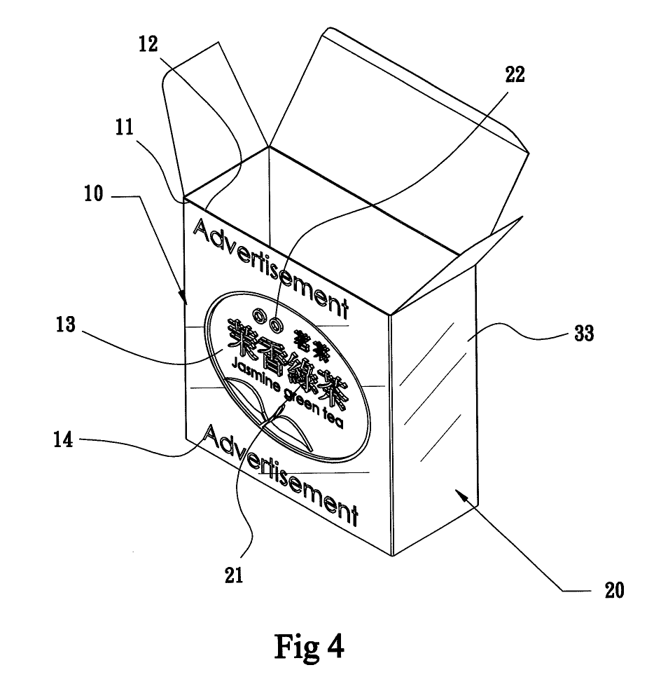

Referring to FIG. 4, an embodiment of the advertisement device according to the present invention applied to a commercial product 20 comprising a tea box 33 is illustrated. In the illustrated embodiment, an advertisement body 10 is adhesively attached to the tea box 33. The advertisement body 10 comprises a hollow viewing window 13 through which indication 21 and brand name 22 are visible and a surrounding area 14 displaying other advertisements.

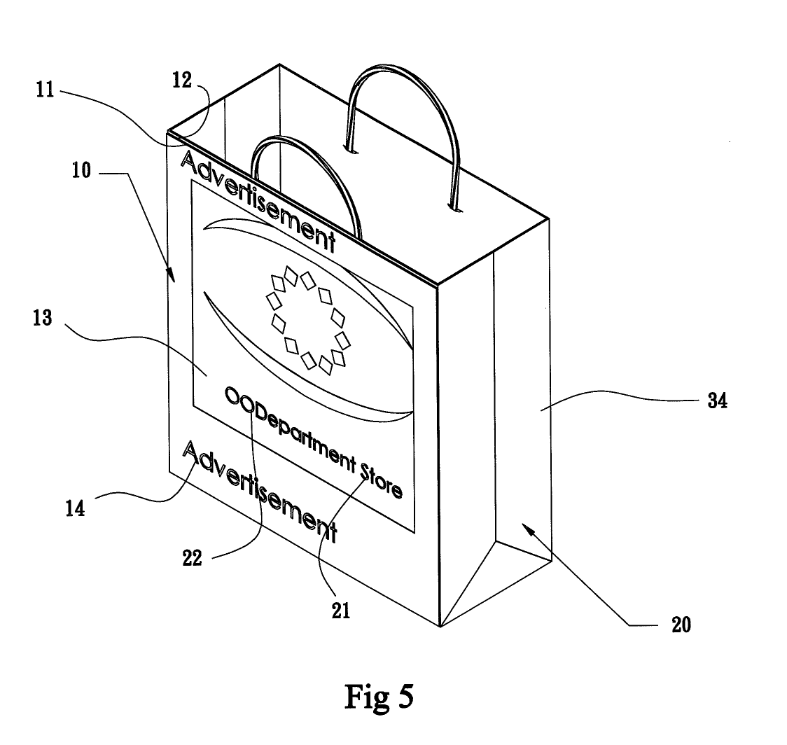

Referring to FIG. 5, an embodiment of the advertisement device according to the present invention applied to a product 20 comprising a shopping bag 34 is illustrated. In the illustrated embodiment, an advertisement body 10 is adhesively attached to a surface of the shopping bag 34. The advertisement body 10 comprises a hollow viewing window 13 through which indication 21 and brand name 22 are visible and a surrounding area 14 displaying other advertisements.

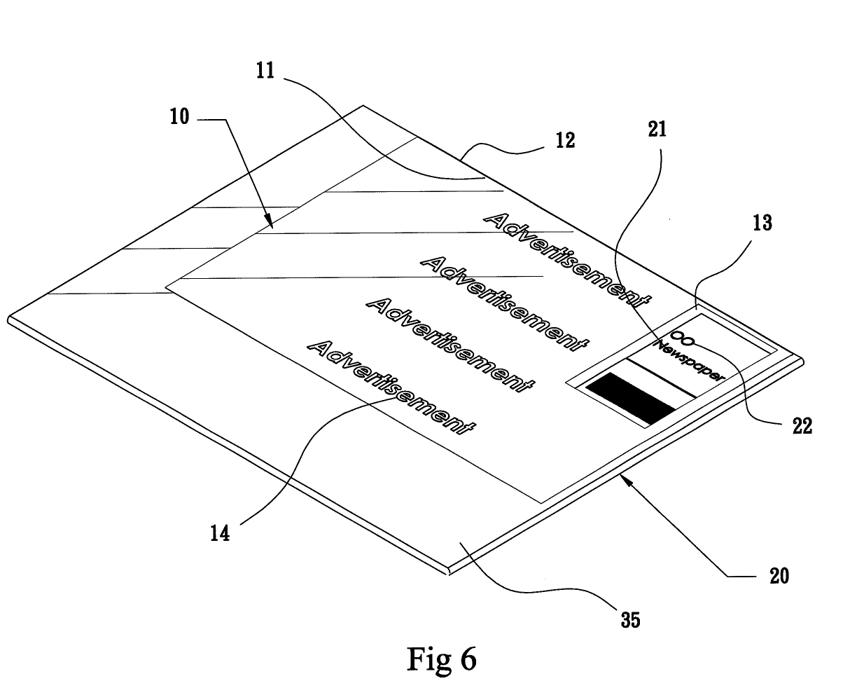

Referring to FIG. 6, an embodiment of the advertisement device according to the present invention applied to a commercial product 20 comprising a newspaper 35 is illustrated. In the illustrated embodiment, an advertisement body 10 is adhesively attached to the newspaper 35. The advertisement body 10 comprises a hollow viewing window 13 through which indication 21 and newspaper title 22 are visible and a surrounding area 14 displaying other advertisements.

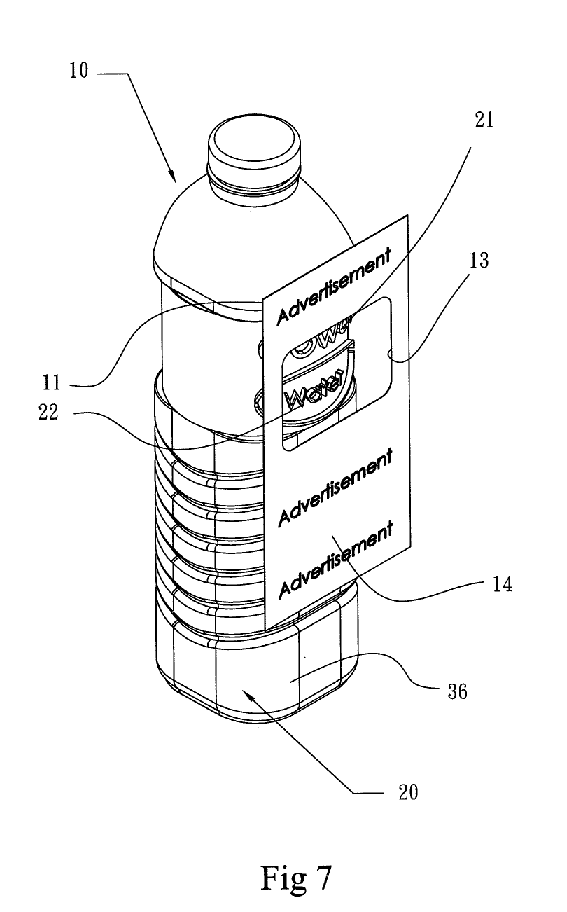

Referring to FIG. 7, an embodiment of the advertisement device according to the present invention applied to a commercial product 20 comprising a beverage bottle 36 is illustrated. In the illustrated embodiment, an advertisement body 10 is adhesively attached to the beverage bottle 36. The advertisement body 10 comprises a hollow viewing window 13 through which indication 21 and brand name 22 are visible and a surrounding area 14 displaying other advertisements.

In the embodiments shown in FIGS. 1-7, the advertisement body 10 is an adhesive planar advertisement body 10.

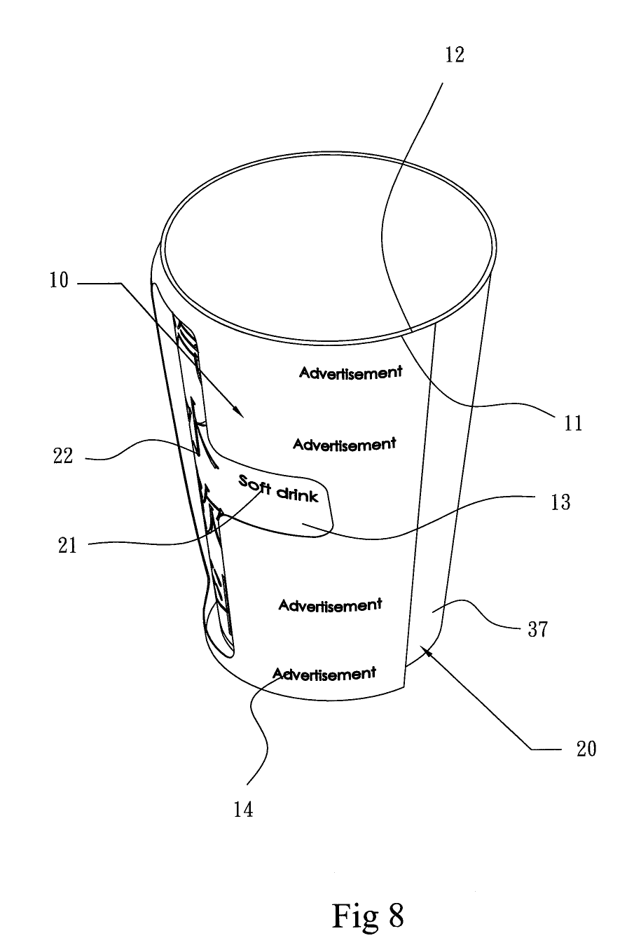

Reference is now made to FIG. 8. An embodiment of the advertisement device according to the present invention applied to a commercial product 20 comprising a beverage cup 37 is illustrated. In the illustrated embodiment, an advertisement body 10 is adhesively attached to the beverage cup 37. The advertisement body 10 comprises a hollow viewing window 13 through which indication 21 and brand name 22 are visible and a surrounding area 14 displaying other advertisements.

In the embodiment shown in FIG. 8, the advertisement body 10 is a circumferentially-surrounding adhesive advertisement body 10.

Further, the attaching back surface 11 of the advertisement body 10 can be mounted to the adhesive tape 12 in advance, or alternatively, after the sale of a commercial product 10, the advertisement body 10 is attached to the product 20 by a clerk.

The attaching back surface 11 of the advertisement body 10 can be adhered to a commercial product 20 before the product 20 is sold or when the product 20 is to be deposited on a freezing chamber or a shelf.

The advertisement body 10 can be made in the form of an advertisement body 10 that carries “points” thereon to be collected by the consumers.

The advertisement body 10 can be made in the form of an advertisement body 10 that carries a coupon attached thereto or printed thereon.

Besides the hollow viewing window 13, the advertisement body 10 also comprises a surrounding area 14 that allows printings of texts or patterns to be made thereon for showing other advertisements so that the present invention provides a practical way for prompting a product. This is a unique feature of the present invention for advertisement and promotion of product.

The advertisement body 10 can be a planer flexible sheet having a back surface to which an adhesive tape 12, such as a double-sided adhesive tape, is attached, or alternatively, adhesive can be applied thereto for adhering to a surface of a commercial product 20 or a shopping bag 34.

The present invention provides the following efficacies:

(1) The present invention provides a hollow self-stick advertisement device, which displays a first form of advertisement and is adhesively attached to a general commodity or a shopping bag so that two “commercial products” are elaborately and ingeniously combined together, forming a novel model of advertising and exhibiting the advantages of convenience of use and diversified arrangement of advertisement.

(2) The present invention provides a hollow self-stick advertisement device, which comprises an advertisement body having at least one back surface that is made adhering and at least one hollow area serving as a viewing window, which can be regular or irregular in shape as long as such a shape highlights any product indications/signs and brand name, whereby patterns or trademark that are printed or otherwise formed on a commercial product or a shopping bag can be clearly viewed through one or more hollow viewing windows, or a transparent film attached to and covering the hollow area of the window.

It is appreciated from the above description that the hollow self-stick advertisement body according to the present invention provides a novel model of advertisement that has never been proposed or known in the art and that is cheap in costs, easy to use, of excellent size selectability, or can be a circumferentially wrapping form or a planar form to provide powerful effect of advertisement. Further, the advertisement body of the present invention can be made in the form of a “commodity point” to be collected by a consumer or even in the form of a coupon for better attracting the consumers.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A hollow self-stick advertisement device, comprising:
a body, which has at least one attaching back surface, which is adapted to attach to a commercial product with an adhesive substance, the advertisement body forming at least one open area serving as a hollow viewing window that is sized according to the commercial product, the hollow viewing window being set to correspond to product information formed on the commercial product so as not to affect identification of the product but highlighting the identification, the body comprising an additional area surrounding the viewing window to receive printings for advertisement other than the commercial product to be made thereon, the body being foldable so that selected portions of the body is foldable around and over sides of the product in a manner not affecting viewing of product information of the commercial product.

2. The hollow self-stick advertisement device as claimed in claim 1, wherein the viewing window is covered with a transparent film.

3. The hollow self-stick advertisement device as claimed in claim 1, wherein the body is an adhesive planar advertisement body.

4. The hollow self-stick advertisement device as claimed in claim 1, wherein the body is a circumferentially-surrounding adhesive advertisement body.

5. low self-stick advertisement device as claimed in claim 1, wherein the back surface of the body is selectively mounted to the adhesive tape in advance, and wherein the body is attached to the commercial product after sale of the product has been made.

6. The hollow self-stick advertisement device as claimed in claim 1, wherein the back surface of the body is attached to the commercial product before the product is sold or when the product is to be deposited on a freezing chamber or a shelf, the body attached to the commercial product being not affecting the identification of the product.

7. The hollow self-stick advertisement device as claimed in claim 1, wherein the body is made in the form that carries points thereon to be collected by a consumer.

8. The hollow self-stick advertisement device as claimed in claim 1, wherein the body is made in the form that carries a coupon.

9. The hollow self-stick advertisement device as claimed in claim 1, wherein the body is selectively provided with various forms of adhering.
